(19) United States
(12) Patent Application Publication
(10) Pub. No.: US 2025/0278322 A1
(43) Pub. Date: Sep. 4, 2025

(54) SYSTEM AND METHOD OF COLLECTING SYSTEM CALLS OF A SPECIFIC PROCESS

(71) Applicant: MEDIA TEK INC., Hsinchu (TW)

(72) Inventor: CHENG HAN TSAI, Hsinchu (TW)

(21) Appl. No.: 18/592,876

(22) Filed: Mar. 1, 2024

(51) Int. Cl. G06F 9/54

(52) U.S. Cl. CPC G06F 9/547

(57) ABSTRACT

In certains aspect of the disclosure, a method, a computer-readable medium, and a system are provided. One aspect of the disclosure relates to a method of collecting system calls of a specific process comprising providing an io control (ioctl) interface from a Linux kernel module comprising a function callback, configured such that when using ioctl, the kernel module registers the callback function for the tracepoint, and all system calls (syscalls) go through the callback function; filtering syscalls with identification of the specific process; and storing index and parameters of the syscalls associated with the specific process.

### BACKGROUND

### Field

The present disclosure relates generally to computer science, and more particularly, to system and method of collecting system calls of a specific process.

### Background

The statements in this section merely provide background information related to the present disclosure and may not constitute prior art.

In computing, a system call is a programmatic way in which a computer program requests a service from the kernel of an operating system (OS) it is executed on. A computer program makes a system call when it makes a request to the operating system's kernel. System call provides the services of the operating system to the user programs via Application Program Interface (API). It provides an interface between a process and an operating system to allow user-level processes to request services of the operating system. System calls are the only entry points into the kernel system. All programs needing resources must use system calls.

A system call is initiated by the program executing a specific instruction, which triggers a switch to kernel mode, allowing the program to request a service from the OS. The OS then handles the request, performs the necessary operations, and returns the result back to the program.

Due to the rapid development of artificial intelligence, more and more applications are developed, and these user space programs need to communicate with the kernel through system calls.

However, most methods of collecting system calls require specific permissions and cannot be simply used from user space.

Therefore, a heretofore unaddressed need exists in the art to address the aforementioned deficiencies and inadequacies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In certain aspects of the disclosure, a method, a computer-readable medium, and an apparatus are provided.

One aspect of the disclosure relates to a method of collecting system calls of a specific process, comprising providing an io control (ioctl) interface from a Linux kernel module (LKM) comprising a function callback, configured such that when using ioctl, the kernel module registers the callback function for the tracepoint, and all system calls (syscalls) go through the callback function; filtering syscalls with identification (ID) of the specific process; and storing index and parameters of the syscalls associated with the specific process.

In one embodiment, said ioctl is disposed within a user space in communication with the LKM disposed within a kernel space.

In one embodiment, the LKM further comprises an LKM entry in communication with the callback function, wherein in operation, a user calls in the LKM entry through said ioctl; a filter in communication with the callback function for filtering the syscalls with said ID of the specific process; and a storage unit in communication with the filter for storing index and parameters of the syscalls associated with the specific process.

In one embodiment, the function callback contains structures including task_struct and pt_regs.

In one embodiment, said task_struct records details of all processes that call in sys_entry, and wherein said pt_regs contains the number of the syscalls and the register value it stores in the central processing unit (CPU).

In one embodiment, said filtering the syscalls with said id of the specific process comprises checking thread group ID (tgid) inside of said task_struct to confirm whether it is the syscalls of the specific process; and said storing the index and the parameters of the syscalls comprises storing the syscall id and the parameters from said pt_regs, when the syscalls of the specific process are confirmed.

In one embodiment, the method further comprises analyzing the syscalls to optimize system performance, detect potential system risks, analyze user behavior, make corresponding system settings, and/or determine which type of applications is using the collected syscalls, and/or tracing the syscalls for system debugging.

Another aspect of the disclosure relates to a system comprising at least one processor configured to perform a method of collecting system calls of a specific process. The method comprises providing an io control (ioctl) interface from a Linux kernel module (LKM) comprising a function callback, configured such that when using ioctl, the kernel module registers the callback function for the tracepoint, and all system calls (syscalls) go through the callback function; filtering syscalls with identification (ID) of the specific process; and storing index and parameters of the syscalls associated with the specific process.

In one embodiment, said ioctl is disposed within a user space in communication with the LKM disposed within a kernel space.

In one embodiment, the LKM further comprises an LKM entry in communication with the callback function, wherein in operation, a user calls in the LKM entry through said ioctl; a filter in communication with the callback function for filtering the syscalls with said ID of the specific process; and a storage unit in communication with the filter for storing index and parameters of the syscalls associated with the specific process.

In one embodiment, the function callback contains structures including task_struct and pt_regs.

In one embodiment, said task_struct records details of all processes that call in sys_entry, and wherein said pt_regs contains the number of the syscalls and the register value it stores in the central processing unit (CPU).

In one embodiment, said filtering the syscalls with said id of the specific process comprises checking thread group ID (tgid) inside of said task_struct to confirm whether it is the syscalls of the specific process; and said storing the index and the parameters of the syscalls comprises storing the syscall id and the parameters from said pt_regs, when the syscalls of the specific process are confirmed.

In one embodiment, the method further comprises analyzing the syscalls to optimize system performance, detect potential system risks, analyze user behavior, make corresponding system settings, and/or determine which type of applications is using the collected syscalls, and/or tracing the syscalls for system debugging.

Yet another aspect of the disclosure relates to a non-transitory tangible computer-readable medium storing instructions which, when executed by one or more processors, cause a method of collecting system calls of a specific process to be performed. The method comprises providing an io control (ioctl) interface from a Linux kernel module (LKM) comprising a function callback, configured such that when using ioctl, the kernel module registers the callback function for the tracepoint, and all system calls (syscalls) go through the callback function; filtering syscalls with identification (ID) of the specific process; and storing index and parameters of the syscalls associated with the specific process. In one embodiment, said ioctl is disposed within a user space in communication with the LKM disposed within a kernel space.

In one embodiment, the LKM further comprises an LKM entry in communication with the callback function, wherein in operation, a user calls in the LKM entry through said ioctl; a filter in communication with the callback function for filtering the syscalls with said ID of the specific process; and a storage unit in communication with the filter for storing index and parameters of the syscalls associated with the specific process.

In one embodiment, the function callback contains structures including task_struct and pt_regs.

In one embodiment, said task_struct records details of all processes that call in sys_entry, and wherein said pt_regs contains the number of the syscalls and the register value it stores in the central processing unit (CPU).

In one embodiment, said filtering the syscalls with said id of the specific process comprises checking thread group ID (tgid) inside of said task_struct to confirm whether it is the syscalls of the specific process; and said storing the index and the parameters of the syscalls comprises storing the syscall id and the parameters from said pt_regs, when the syscalls of the specific process are confirmed.

In one embodiment, the method further comprises analyzing the syscalls to optimize system performance, detect potential system risks, analyze user behavior, make corresponding system settings, and/or determine which type of applications is using the collected syscalls, and/or tracing the syscalls for system debugging. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an exemplary configuration of a system of collecting system calls of a specific process, according to some embodiments.

FIG. 2 shows a flowchart for collecting system calls of a specific process, according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In computing, operating systems generally divide the virtual memory into kernel space and user space. The kernel space is a memory space where the core of the operating system (kernel) executes and provides its service. The kernel space is reserved for running device drivers, operating system kernel, and all other kernel extensions. The user space is also known as userland and is a memory space where all user applications or application software executes. Everything other than operating system cores and kernel runs in the user space. User process can access the kernel space through system calls. A system call (syscall) is a programmatic way in which a computer program requests a service from the kernel of an operating system (OS) it is executed on, that is, a way for a program to interact with the underlying system, such as accessing hardware resources or performing privileged operations. A user program can interact with the operating system using a system call. Usually, a number of services are requested by the program, and the OS responds by launching a number of systems calls to fulfill the request.

Syscall monitoring is the act of gaining execution, in some context, before an application can successfully pass its tasking to the OS. System call monitoring can detect and control compromised applications by checking at runtime that each system call conforms to a policy that specifies the program's normal behavior. As the systems become busier and more strained, there is usually a corresponding increase in the volume of syscall activity. As these interactions occur with great frequency, the system call monitoring must ensure a minimal performance impact on the activity. However, most existing methods of monitoring the syscalls require specific permissions and cannot be simply used from the user space (userspace).

In view of the foregoing, this invention in one aspect discloses a new approach to implementing system call collection and monitoring from the user space. This method provides a way to gather system calls and administrative privileges yourself from the user space, which ensures the minimal performance impact on the syscalls activity.

In some embodiments, the method of collecting system calls of a specific process from the user space includes providing an io control (ioctl) interface from a Linux kernel module (LKM) comprising a function callback, configured such that when using ioctl, the kernel module registers a callback function for the tracepoint, and all system calls (syscalls) go through the callback function; filtering syscalls with identification (ID) of the specific process; and storing index and parameters of the syscalls associated with the specific process.

In some embodiments, said ioctl is disposed within the user space in communication with the LKM disposed within the kernel space. Operably, a user can collect and/or monitor the system calls by calling in the LKM through said ioctl in the user space.

In some embodiments, the function callback contains structures including task_struct and pt_regs.

In some embodiments, said task_struct contains details of all processes that call in sys_entry, including, but not limited to, process IDs, syscall IDs, and sequences of all the syscalls.

In some embodiments, said pt_regs contains the number of the syscalls and the register value it stores in the central processing unit (CPU).

In some embodiments, said filtering the syscalls with said ID of the specific process comprises checking thread group ID (tgid) inside of said task_struct to confirm whether it is the syscalls of the specific process. In other words, said filtering step selectively collects/monitors the syscalls of the specific process only. It should be noted that by changing certain filtering criteria, said filtering step can collect/monitor the syscalls of different processes and/or all the processes according to some embodiments of the invention.

In some embodiments, said storing the index and the parameters of the syscalls comprises storing the syscall IDs and the parameters from said pt_regs, when the syscalls are of the specific process. similarly, said storing step selectively store the syscalls of the specific process only. It should be noted that by changing certain filtering criteria, said storing step can store the syscalls of different processes and/or all the processes according to some embodiments of the invention.

In some embodiments, the information of the collected/monitored syscalls can be analyzed for different applications, such as optimizing system performance, detecting potential system risks, analyzing user behavior, making corresponding system settings, determining which type of applications is using the collected syscalls, system debugging, or the like.

In some embodiments, the method further comprises analyzing the syscalls to optimize system performance, detect potential system risks, analyze user behavior, make corresponding system settings, and/or determine which type of applications is using the collected syscalls.

In some embodiments, the method further comprises tracing the syscalls for system debugging.

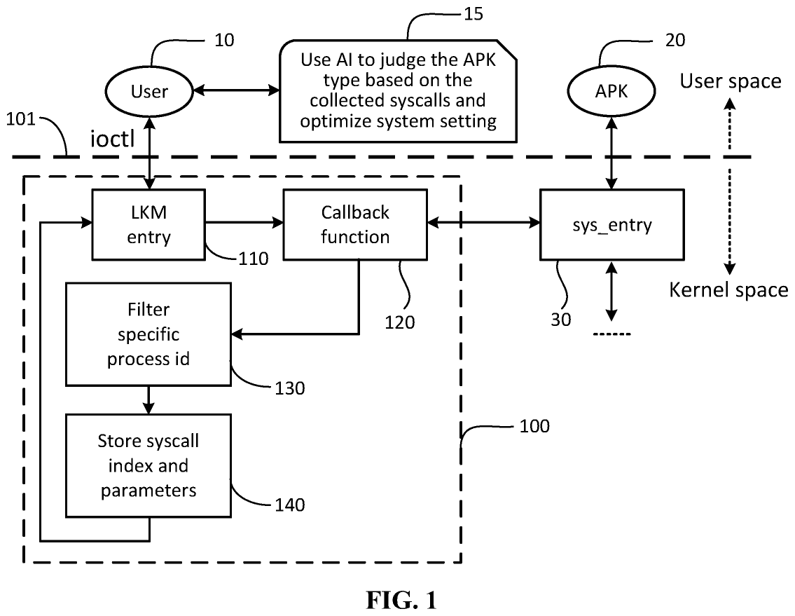

Referring to FIG. 1, the LKM 100 for sequential collection of system calls in some embodiments comprises a callback function 120 that is registered within the kernel for the tracepoint. As such, all system calls (syscalls) go through the callback function 120. For example, when a user application such as APK 20 requests a service from the kernel of the OS it is executed on, it makes one or more syscalls in sys_entry 30 in the kernel space. The one or more syscalls go through the callback function 120.

The LKM 100 also includes an LKM entry 110 in communication with the callback function 120. In operation, a user 10 using said ioctl in the user space calls in the LKM entry 110 through the ioctl interface 101, the LKM entry 110 is, in turn, coupled with the callback function 120 that records all the syscalls.

In addition, the LKM 100 further includes a filter 130 coupled and in communication with the callback function 120 for filtering the syscalls with said ID of the specific process; and a storage unit 140 coupled and in communication with the filter 130 for storing index and parameters of the syscalls associated with the specific process.

The information of the collected/monitored syscalls can be analyzed for different applications 15, such as optimizing system performance, detecting potential system risks, analyzing user behavior, making corresponding system settings, determining which type of applications is using the collected syscalls, system debugging, or the like.

In some embodiments, the method selectively collects/monitors the syscalls of the specific process only. It should be noted that the method can also be utilized to collect/monitor the syscalls of different processes and/or all the processes. Accordig to the invention, the method of system call collection and monitoring from the user space minimizes system resource consumption and ensures the correctness of collected data.

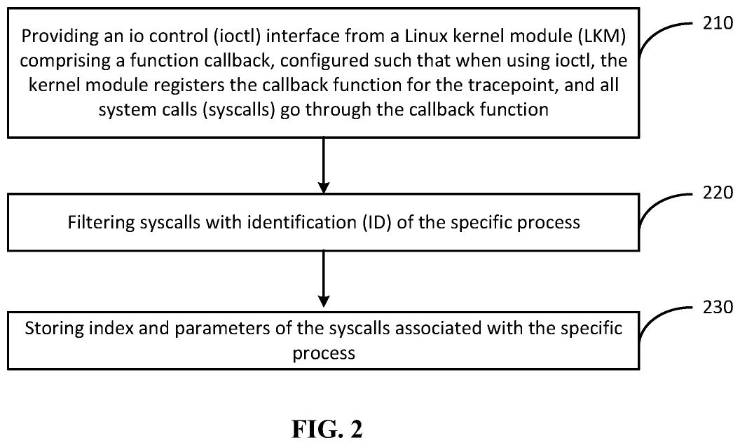

Referring to FIG. 2, a flowchart for the method of collecting system calls of a specific process is shown according to some embodiments of the invention.

According to the method, at step 210, an io control (ioctl) interface is provided from a Linux kernel module (LKM) comprising a function callback, configured such that when using ioctl, the kernel module registers the callback function for the tracepoint, and all system calls (syscalls) go through the callback function.

In some examples, said ioctl is disposed within a user space in communication with the LKM disposed within a kernel space.

In some examples, the LKM further comprises an LKM entry in communication with the callback function, wherein in operation, a user calls in the LKM entry through said ioctl; a filter in communication with the callback function for filtering the syscalls with said ID of the specific process; and a storage unit in communication with the filter for storing index and parameters of the syscalls associated with the specific process.

In some examples, the function callback contains structures including task_struct and pt_regs.

In some examples, said task_struct records details of all processes that call in sys_entry, and wherein said pt_regs contains the number of the syscalls and the register value it stores in the central processing unit (CPU).

According to the method, at step 220, the syscalls are filtered with identification (ID) of the specific process.

According to the method, at step 230, the index and parameters of the syscalls associated with the specific process are stored.

In some examples, said filtering the syscalls with said id of the specific process comprises checking thread group ID (tgid) inside of said task_struct to confirm whether it is the syscalls of the specific process. said storing the index and the parameters of the syscalls comprises storing the syscall id and the parameters from said pt_regs, when the syscalls of the specific process are confirmed.

In some examples, the method may also include analyzing the syscalls to optimize system performance, detect potential system risks, analyze user behavior, make corresponding system settings, and/or determine which type of applications is using the collected syscalls, and/or tracing the syscalls for system debugging.

It should be noted that all or a part of the steps of the method according to the embodiments of the invention is implemented by hardware or a software module executed by a processor, or implemented by a combination thereof. In one aspect, the invention provides a system comprising at least one processor configured to perform the method of collecting system calls of a specific process as disclosed above.

Yet another aspect of the invention provides a non-transitory tangible computer-readable medium storing instructions which, when executed by one or more processors, cause a system to perform the above-disclosed method of collecting system calls of a specific process. The computer executable instructions or program codes enable a computer or a similar computing system to complete various operations in the above disclosed method of foveated rendering of omnidirectional media content. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, other non-volatile solid state storage devices, or any other type of non-transitory computer readable recoding medium commonly known in the art.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C.

Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of collecting system calls of a specific process, comprising:
providing an io control (ioctl) interface from a Linux kernel module (LKM) comprising a function callback, configured such that when using ioctl, the kernel module registers the callback function for the tracepoint, and all system calls (syscalls) go through the callback function;
filtering syscalls with identification (ID) of the specific process; and
storing index and parameters of the syscalls associated with the specific process.

2. The method of claim 1, wherein said ioctl is disposed within a user space in communication with the LKM disposed within a kernel space.

3. The method of claim 1, wherein the LKM further comprises:
an LKM entry in communication with the callback function, wherein in operation, a user calls in the LKM entry through said ioctl;
a filter in communication with the callback function for filtering the syscalls with said ID of the specific process; and
a storage unit in communication with the filter for storing index and parameters of the syscalls associated with the specific process.

4. The method of claim 1, wherein the function callback contains structures including task_struct and pt_regs.

5. The method of claim 4, wherein said task_struct records details of all processes that call in sys_entry, and wherein said pt_regs contains the number of the syscalls and the register value it stores in the central processing unit (CPU).

6. The method of claim 5,
wherein said filtering the syscalls with said id of the specific process comprises checking thread group ID (tgid) inside of said task_struct to confirm whether it is the syscalls of the specific process; and
wherein said storing the index and the parameters of the syscalls comprises storing the syscall id and the parameters from said pt_regs, when the syscalls of the specific process are confirmed.

7. The method of claim 1, further comprising:
analyzing the syscalls to optimize system performance, detect potential system risks, analyze user behavior, make corresponding system settings, and/or determine which type of applications is using the collected syscalls, and/or
tracing the syscalls for system debugging.

8. A system, comprising:
at least one processor configured to perform a method of collecting system calls of a specific process, the method comprising:
providing an io control (ioctl) interface from a Linux kernel module (LKM) comprising a function callback, configured such that when using ioctl, the kernel module registers the callback function for the tracepoint, and all system calls (syscalls) go through the callback function;
filtering syscalls with identification (ID) of the specific process; and
storing index and parameters of the syscalls associated with the specific process.

9. The system of claim 8, wherein said ioctl is disposed within a user space in communication with the LKM disposed within a kernel space.

10. The system of claim 8, wherein the LKM further comprises:
an LKM entry in communication with the callback function, wherein in operation, a user calls in the LKM entry through said ioctl;
a filter in communication with the callback function for filtering the syscalls with said ID of the specific process; and
a storage unit in communication with the filter for storing index and parameters of the syscalls associated with the specific process.

11. The system of claim 8, wherein the function callback contains structures including task_struct and pt_regs.

12. The system of claim 11, wherein said task_struct records details of all processes that call in sys_entry, and wherein said pt_regs contains the number of the syscalls and the register value it stores in the central processing unit (CPU).

13. The system of claim 12,
wherein said filtering the syscalls with said id of the specific process comprises checking thread group ID (tgid) inside of said task_struct to confirm whether it is the syscalls of the specific process; and
wherein said storing the index and the parameters of the syscalls comprises storing the syscall id and the parameters from said pt_regs, when the syscalls of the specific process are confirmed.

14. The system of claim 8, wherein the method further comprises:
analyzing the syscalls to optimize system performance, detect potential system risks, analyze user behavior, make corresponding system settings, and/or determine which type of applications is using the collected syscalls, and/or
tracing the syscalls for system debugging.

15. A non-transitory tangible computer-readable medium storing instructions which, when executed by one or more processors, cause a method of collecting system calls of a specific process to be performed, the method comprising:
providing an io control (ioctl) interface from a Linux kernel module (LKM) comprising a function callback, configured such that when using ioctl, the kernel module registers the callback function for the tracepoint, and all system calls (syscalls) go through the callback function;
filtering syscalls with identification (ID) of the specific process; and
storing index and parameters of the syscalls associated with the specific process.

16. The non-transitory tangible computer-readable medium of claim 15, wherein said ioctl is disposed within a user space in communication with the LKM disposed within a kernel space.

17. The non-transitory tangible computer-readable medium of claim 15, wherein the LKM further comprises:
an LKM entry in communication with the callback function, wherein in operation, a user calls in the LKM entry through said ioctl;
a filter in communication with the callback function for filtering the syscalls with said ID of the specific process; and
a storage unit in communication with the filter for storing index and parameters of the syscalls associated with the specific process.

18. The non-transitory tangible computer-readable medium of claim 15, wherein the function callback contains structures including task_struct and pt_regs.

19. The non-transitory tangible computer-readable medium of claim 18, wherein said task_struct records details of all processes that call in sys_entry, and wherein said pt_regs contains the number of the syscalls and the register value it stores in the central processing unit (CPU).

20. The non-transitory tangible computer-readable medium of claim 19,
wherein said filtering the syscalls with said id of the specific process comprises checking thread group ID (tgid) inside of said task_struct to confirm whether it is the syscalls of the specific process; and
wherein said storing the index and the parameters of the syscalls comprises storing the syscall id and the parameters from said pt_regs, when the syscalls of the specific process are confirmed.

21. The non-transitory tangible computer-readable medium of claim 15, wherein the method further comprises:
analyzing the syscalls to optimize system performance, detect potential system risks, analyze user behavior, make corresponding system settings, and/or determine which type of applications is using the collected syscalls, and/or
tracing the syscalls for system debugging.
